(19) United States
(12) Patent Application Publication
(10) Pub. No.: US 2021/0042705 A1
(43) Pub. Date: Feb. 11, 2021

(54) NETWORK COMPUTER SYSTEM TO PROVIDE FLEET MANAGEMENT SERVICE

(71) Applicant: Uber Technologies, Inc., San Francisco, CA (US)

(72) Inventors: Yuk Lai Suen, San Francisco, CA (US); Mohini Thakkar, San Francisco, CA (US); Di Li, San Francisco, CA (US); Yujia Luo, San Francisco, CA (US); Bryant Luong, San Francisco, CA (US); Lauren Foster, San Francisco, CA (US); Mei Xue, San Francisco, CA (US); Steven Sanburn, San Francisco, CA (US); Gony Noy, San Francisco, CA (US); Stefan Sohlstrom, San Francisco, CA (US); Shahar Zimmerman, San Francisco, CA (US)

(21) Appl. No.: 16/986,181

(22) Filed: Aug. 5, 2020

Related U.S. Application Data
(60) Provisional application No. 62/883,113, filed on Aug. 5, 2019.

(51) Int. Cl. G06Q 10/10; G06Q 30/08; G06Q 10/06; G06Q 10/08; G06Q 10/02; G06F 9/451

(52) U.S. Cl. CPC G06Q 10/103; G06Q 30/08; G06Q 10/1097; G06Q 10/063114; G06F 9/451; G06Q 10/06315; G06Q 10/0835; G06Q 10/0838; G06Q 10/02; G06Q 10/063118

(57) ABSTRACT

A network computer system operates to store a plurality of records, where the plurality of records identify (i) a plurality of shipment orders, and (ii) a plurality of freight operators. The record for each shipment order identifies a set of shipment parameters for that shipment order, and the record for each freight operators identifies availability information for the freight operator. One or more matching processes are performed using the plurality of records, to match shipment orders and freight operators. The network computer system generates a preview panel to display matchings as between shipment orders of the plurality of shipments orders, and available freight operators of the plurality of freight operators.

### RELATED APPLICATIONS

This application claims benefit of priority to Provisional Application No. 62/883,113, filed Aug. 5, 2019; the aforementioned priority application being hereby incorporated by reference in its entirety for all purposes.

### TECHNICAL FIELD

Examples described herein relate to a network computer system to provide fleet managers with a fleet management service.

### BACKGROUND

Freight and shipping are vital aspects of modern society, and technological that promote efficiency in the freight industry is increasingly an area of research and improvement. Traditionally, freight vehicles were owned and operated as part of a larger fleet, and the role of managing the fleet would fall in part on dispatchers who would assign shipment orders to freight operators. The freight operators would in turn operate one of the fleet's freight vehicles to complete a shipment.

In recent years, owner-operated freight vehicles and independent freight operators have become more prevalent in the freight industry. Additionally, the relationship between owner freight operators and large fleet managers has become increasingly fluid, with large freight operators readily engaging owner-operated and independent freight operators as needed. Additionally, small and mid-size fleet managers have emerged who manage multiple freight vehicles at one time. In order to minimize the downtime of their vehicles, fleet managers often loan freight vehicles and/or operators to other fleet managers, as well as borrow freight vehicles as needed. As a result, the freight vehicles and operators which constitute the freight inventory of a given fleet is sometimes determined on an ad-hoc basis, and the number of freight vehicles and operators for some fleets can vary from day-to-day.

Managing fleets of freight vehicles is a complex exercise. Fleet managers locate and book shipments for their fleet, while assigning shipments to freight vehicles of the fleet in a manner that minimizes costly inefficiencies such as freight vehicle downtime or dead-head driving (where freight vehicles are driven without shipment, such as to pickup a new shipment). The industry has developed technological products and services to facilitate in the management of fleets of freight vehicles, with objectives such as optimizing freight vehicles down time, deadhead driving and fuel consumption. One type of tool that has been developed to facilitate fleet managers in managing freight vehicles are Transport Management Systems (“TMS”). Numerous TMS products exist which provide various types of technological features for monitoring and tracking freight vehicles and performing other tasks related to the management of freight vehicles. While TMS products facilitate fleet managers with managing various aspects of their fleets, fleet managers generally need other resources and tools to find shipments for their freight operators to haul.

Another type of tool that is commonly used by carriers and freight operators are loadboard applications. Loadboard applications publish information about available shipments which a freight operator can be selected to load and deliver. Typically, loadboard applications identify the location of new or open shipments, the compensation value of the shipment, and information about the load (e.g., size of load). Some services enable carriers and freight operators to search for new shipments based on their current location, or alternatively, based on a manually entered location. When a carrier or freight operator uses a loadboard application to find a new shipment, the freight operator typically contracts for the shipment, either directly or through a service that accompanies the loadboard application. These and similar loadboard applications serve a primary function of aggregating and publishing information about new shipment requests, with the carriers and individual freight operator being able to filter results based on location or other criteria (e.g., size of shipment). Many loadboard applications are designed to facilitate freight vehicle owners and independent carriers. However, recently, products such as JB HUNT CARRIER 360 have allowed fleet managers to book shipments and to assign shipments to freight operators of their fleet.

### BRIEF DESCRIPTION OF THE DRAWINGS

FIG. 1 illustrates an example network computer system for providing a fleet management service for fleet managers.

FIG. 2A illustrates an example method for providing a fleet management service, according to one or more examples.

FIG. 2B illustrates another example method for providing a fleet management service, according to one or more examples.

FIG. 3A through FIG. 3I illustrate an example freight management user-interface, according to various examples.

FIG. 4 illustrates a computer system on which one or more examples can be implemented.

### DETAILED DESCRIPTION

According to examples, a network computer system provides a service for managing a fleet of freight resources. The network computer system operates to store a plurality of records, where the plurality of records identify (i) a plurality of shipment orders, and (ii) a plurality of freight operators. The record for each of the plurality of shipment orders identifies a set of shipment parameters for that shipment order. Additionally, the record for each of the plurality of freight operators identifies availability information for the freight operator. The network computer system performs one or more matching processes using the plurality of records, to match shipment orders of the plurality of shipment orders and freight operators of the plurality freight operators. The network computer system performs one or more matching processes using at least the set of shipment parameters identified by the record for each shipment order of the plurality of shipment orders and the freight activity information of each freight operator of the plurality of freight operators. In some examples, the network computer system generates a preview panel to display to the fleet manager matchings as between shipment orders of the plurality of shipments orders, and available freight operators of the plurality of freight operators.

In examples, preview panel may be interactive to enable the fleet manager to perform actions such as (i) book open shipment orders after viewing available freight operators that can fulfill the shipment order, and/or (ii) assign booked shipment orders with freight operators that are available to fulfill those shipment orders. The preview panel further generates an output to implement the selections of the freight operator. For example, the preview panel can implement one or more processes to automate (or substantially automate) booking of an open shipment order identified through the preview panel. As another example, the preview panel can implement one or more processes to notify a freight operator of a matched and booked shipment order.

In some examples, the matchings are made to optimize one or more objectives of the fleet manager. For example, the network computer system implements the matching process such that a booked shipment order is matched to a freight operator that requires the least amount of driving to pickup up the shipment order.

Examples recognize that the freight industry has specific challenges related to fleet management of freight vehicles. These challenges generally include communication with freight operators: the freight vehicles are constantly moving across a large geographic territory, and direct person-to-person communication can be challenging, particularly if the communications distract the freight operator. Moreover, additional inefficiency resulting from communication can be introduced as a result of fleet managers using freight vehicle owners and independent freight operators. A fleet manager may have limited ability to view the availability of such independent freight operators, as such freight operators may take assignments from multiple carriers.

Additionally, many of the technological products available to the freight industry is intended to make efficient use of freight vehicles. But the products focus on specific aspects of freight operation. For example, TMS products can facilitate fleet managers in identifying the best route individual freight operators are to use when hauling a particular shipment, predicting when a shipment will arrive at its destination, monitoring use of freight vehicles for maintenance, and other facets. Examples recognize that to the extent inefficiency exists in how freight vehicles are utilized within a fleet, the underlying technologies which are used to manage the freight vehicles within the fleet become less useful. For example, while many conventional TMS products identify best routes for freight operators, such products do not match shipments to available freight operators of the fleet. If freight operators are assigned to haul shipments which require an unnecessary amount of driving by the freight vehicle to pickup the shipment, then usefulness of the TMS product is lessened.

These types of challenges illustrate the problems that arise for fleet managers in utilizing available technological resources to manage their fleet. In a typical workflow, a fleet manager (i) locates shipments (or loads) for the fleet to haul, and (ii) books shipments, meaning the fleet manager commits to hauling a given shipment in accordance with specified shipment parameters of the new shipments. To book loads, fleet managers determine the availability and location of available freight operators in their fleet. Once booked, fleet managers typically have an additional step to perform—that of assigning their booked shipment to a freight operator.

The acts of booking new shipments and assigning new shipments can be arduous tasks, given the inherent challenges of the freight industry with respect to communications. Under conventional approaches, fleet managers use a TMS product to determine availability and current or future locations of their freight operators. To book new shipments for the fleet, however, the freight operator typically utilizes other resources, such as loadboards. Still further, assigning new shipments to freight operators can, under conventional approaches, be done through the TMS product and/or using other services, such as freight communication services.

However, even with TMS products, under conventional approaches, matching available freight operators of a fleet to booked shipment orders typically involves (i) decision making on the part of the fleet manager, and/or (ii) bidding on the part of the freight operator. Fleet managers often utilize preferences, judgement or their own criteria for matching new shipments to available freight vehicles—however, fleet managers are often not equipped to base matching decisions on factors of efficiency (e.g., amount of dead-head driving required to pickup new shipment). Making matters more difficult, fleet managers may need to communicate with freight operators before matching takes place. If, for example, communications are conducted through messaging, the fleet manager waits for a response. When multiple shipments are to be matched, the delays and difficulties which arise from communication can cascade, causing numerous communication exchanges, delay assignment of new shipments to freight operators, and can also make some frieght operator-to-shipment assignments contingent or dependent on other assignments or events. Under conventional approaches, the delays and difficulties arising from the inherent challenges of communications as between freight operators and managers can hamper the efficacy of the decision making in matching booked shipments to available freight operators.

In this context, examples provide an improvement that addresses the problems which arise from the available technologies which are used to manage fleets of freight vehicles. Among other improvements, an example network computer system enables a fleet manager to use a common account interface to book multiple open shipment orders and then assign the booked shipment orders to multiple freight operators of the fleet. Moreover, the fleet manager can assign booked shipment orders in batches to different freight operators of a fleet, with the matching between freight operator and open shipment order being optimized for one or more predetermined objectives, such as to to maximize efficiency by reducing dead-head driving amongst the freight operators of the fleet. Moreover, by providing a common account interface, examples allow for the fleet manager to utilize a single service or product to perform a fleet manager workflow of booking and assigning shipment orders. Additionally, examples enable fleet managers to obtain full benefit of other types of technological products (e.g., TMS products) which allow fleet managers to manage freight resources to optimize efficiency.

Still further, examples allow for the fleet manager to identify those freight operators who are available to the fleet manager during specific time intervals, without the fleet manager having to directly communicate with any of the freight operators after shipment orders are booked. In some examples, each freight operator that operates a freight vehicle of a given fleet can be associated with a freight operator interface that obtains the availability information of a freight operator for that fleet.

In context of examples described, the term “optimal” or its variants (e.g., “optimize”, “optimization”), as well as related expressions such as “maximize” or “minimize”, refers to a determination or action that is made to further a predetermined objective, such as improvement of efficiency (e.g., reduction of deadhead driving, increase use of freight vehicle, etc.).

With regard to examples as described, a fleet manager refers to a user who has a role of managing a fleet of freight vehicles. A freight operator refers to an individual who operates a freight vehicle. Freight resources may include freight operators and/or vehicles.

In some examples, each freight vehicle includes a truck (or tractor) and trailer, with the trailer being separable from the truck. In variations, each freight vehicle can correspond to any vehicle that is capable of carrying a shipment load. By way of example, freight vehicles can include tractor units (sometimes referred as to as “semis” or “semi-tractors”), flatbed trucks, cargo vans, box trucks, and numerous types of specialized trucks (e.g., tank trucks to carry flammable liquid, refrigerated trucks, etc.).

Mobile devices (e.g., freight operator device, shipper device, etc.), as described with various examples, include multi-functional messaging and/or telephony device of the freight operator (e.g., feature phone, smart phone, phablet, tablet, ultramobile computing device, etc.). In examples, the service application can be executed to provide a freight operator interface that enables the freight operator to enter input that identifies the availability status of the freight operator. For example, the freight operator can provide input that indicates the availability status of the freight operator during a future time interval. As an addition or alternative, the freight operator interface can be generated to prompt the freight operator to enter input that identifies, for example, the type of vehicle and/or capacity of the freight vehicle that the freight operator operates during the future time interval.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

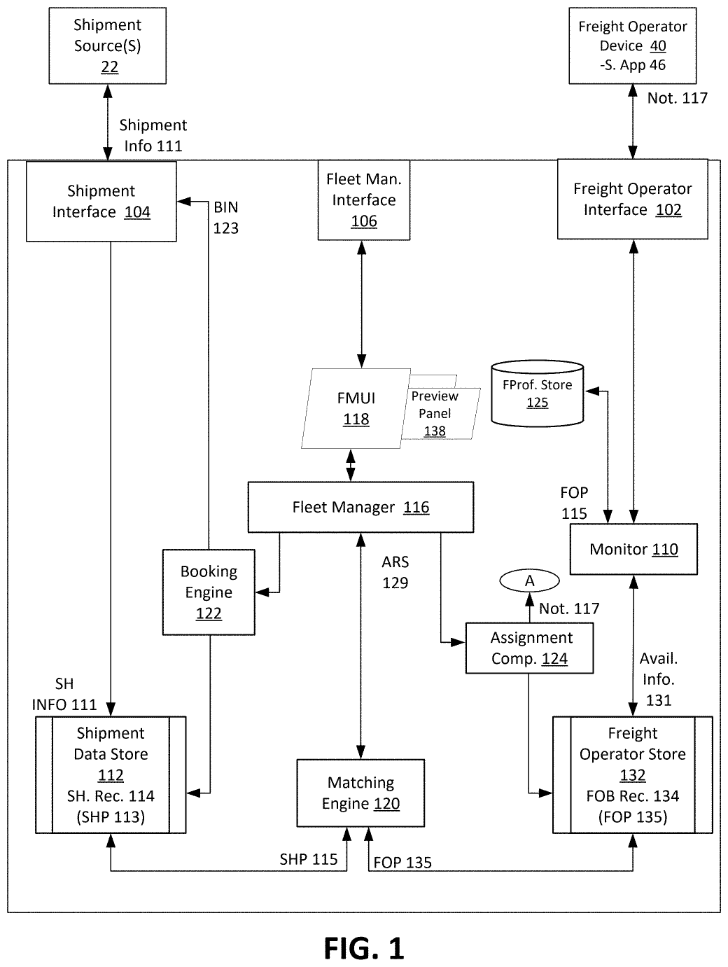

FIG. 1 illustrates a network computer system to provide a fleet management service of freight resources. As described by various examples, network computer system 100 provides a fleet management service for a manager of a fleet of freight vehicles (“fleet manager”). A fleet manager can correspond to an end-user having roles of booking open shipment orders, which may be identified through the network computer system 100, and assigning shipment orders to freight operators. Additionally, the fleet manager can perform other tasks such as tracking freight operators as they fulfill shipment orders and anticipating delays or timeliness with respect to freight operators of the fleet completing shipments.

In examples, a fleet manager enrolls with the fleet management service by setting up an account using a fleet manager interface 106. The fleet manager interface 106 can be implemented as a web portal or service application. For example, the fleet manager interface 106 can be provided through a web service which the fleet manager can access using a browser or mobile device application. As described by various examples, in providing the fleet management service for a given fleet manager, the network computer system 100 generates a customized and interactive user-interface that enables the fleet manager to (i) view information about shipment orders and available freight operators, (ii) view matchings of shipment orders to available freight operators, (iii) book open shipment orders based on matchings and other information, and (iv) assign available freight operators to booked shipment orders.

In some examples, the network computer system 100 implements a fleet management workflow to (i) book or otherwise acquire shipment orders for a fleet, (ii) obtain availability information for each freight operator, (iii) implement matching or pre-matching of shipment orders with available freight operators of the fleet, and (iv) communicate and/or confirm assignments of shipment orders with matched freight operators. The network computer system 100 can implement aspects of the fleet management workflow in conjunction with providing the fleet manager with a customized and interactive user-interface to facilitate decision making and execution of fleet management tasks.

According to examples, the network computer system 100 can be implemented in a variety of computing environments, including as part of a network service provided through one or more servers. The network computer system 100 may be implemented on a server, on a combination of servers, and/or on a distributed set of computing devices which communicate over a network 99, such as the Internet. Still further, the fleet manager can access the fleet management service using a web portal (e.g., desktop browser) or specialized service application executing on the mobile device of the fleet manager.

Booking and Shipment Order Acquisition

In examples, the network computer system 100 implements processes to (i) acquire information about open shipment orders from one or more shipment sources, and (ii) book open shipment orders based on user input and/or programmatic input. With reference to an example of FIG. 1, booking and shipment order acquisition processes can be implemented by one or more shipment interfaces 104, booking engine 122 and shipment store 112. The shipment interfaces 104 includes processes to communicate with shipment sources 22 (e.g., shipper mobile device or shipping accounts), to receive or retrieve shipment information 111 that correspond to open shipment orders. The shipment source 22 can include a web portal (e.g., shipper logs into a web-based account interface to identify shipment orders) and/or device application interface (e.g., shipper uses a shipper application running on a shipper mobile device to identify shipment orders and perform other shipping operations). By way of example, a shipper can use a shipment source 22 to access and complete a form that specifies shipment information 111, such as pickup and drop-off locations, type of shipment (or type of freight vehicle requested), and compensation for hauling the shipment. In some variations, the shipment source 22 includes an electronic loadboard or listing service for open shipment orders. The shipment interface 104 can interface or otherwise access the electronic loadboard to retrieve the shipment information 111 about published and open shipment orders.

In examples, the network computer system 100 can includes a shipment store 112 to shipment information 111. The shipment interface 104 can, for example, populate shipment records 114 of shipment store 112 with acquired shipment information 111 of open or booked shipment orders. The shipment store 112 can parameterize the shipment information 111 for individual shipment orders that are acquired through the shipment interface 104. Each shipment record 114 can be associated with an identifier of a shipment order, as well as a set of shipment parameters 113, including a shipment pickup location, a shipment delivery location, and a pickup time or window, and a drop-off time or window. The shipment parameters 113 can also specify information about a characteristic of the shipment load, such as a size of the shipment load (e.g., dimension or weight), a type of the shipment load (e.g., refrigerated), and/or a type of vehicle that is required or preferred for transporting the shipment load.

In examples, the booking engine 122 identifies shipment records 114 of open shipment orders from the shipment store 112. Additionally, the booking engine 122 can communicate booking input 123 to the shipment source 22 to book selected open shipping orders with the respective shipment source 22. Once booked, the fleet manager is committed to fulfill the shipment order. As described with some examples, the booking input 123 can be generated in response to fleet manager input, and/or automatically generated based on a determined need or preference of the fleet manager and/or freight operators of the respective fleet. The booking input 123 can identify, for example, an identifier of a selected shipment order (and a corresponding shipper source identifier), an account identifier of the fleet manager, and an identifier of the selected open shipment orders which are to be booked for the fleet. The booking engine 122 can further obtain confirmation that the selected shipping orders of the booking input 123 are booked. The booking engine 122 can also update the shipment records 114 of the select shipping orders to reflect the status of the open shipment orders as booked.

In variations, the shipment interface 104 and/or booking engine 122 implements a search process to identify shipping orders that match one or more shipment criteria of the fleet manager. The search process can be implemented to retrieve candidate open shipment orders, from which the fleet manager can select which open shipment orders to book. As an addition or variation, the search process can filter the shipment records 114 stored with the shipment store 112, to identify candidate open shipment orders from which the booking selections can be made by the fleet manager. As described with some examples, the search criteria for identifying open shipment orders is specified by the fleet manager. In variations, the search criteria can be determined programmatically, based on, for example, availability parameters for individual freight operators of the fleet.

Still further, in some examples, the booking engine 122 implements a booking process automatically, such as based on a schedule, or in response to a fleet manager input or other trigger. The booking engine 122 can determine a fleet booking criteria that is based on shipment parameters 113 associated with shipment records 114 for open shipment orders. For example, the fleet booking criteria can identify a pickup location, destination, a lane (e.g., pickup and destination), or a shipper. The fleet booking criteria can be predetermined (e.g., stored as a preference of the fleet manager). As an addition or alternative, the fleet booking criteria can be determined based on, for example, a history of open shipment orders which the fleet manager has recently booked, and/or lanes or shipment orders which freight operators associated with the freight operator account have recently or most frequently completed. In examples, the shipment interface 104 can access one or multiple shipment sources 22 to identify shipment orders which satisfy the fleet booking criteria. In this way, once open shipment orders are identified which satisfy the fleet booking criteria, the shipment interface 104 can implement steps to book the shipment order.

Freight Operator Availability Determination

In examples, the network computer system 100 also implements processes to determine availability of freight operators of a fleet. The network computer system 100 determines the availability of individual freight operators for one or more upcoming time intervals, coinciding with pickup times or windows for new shipment orders which the fleet manager has or may book (e.g., next day, future window of time, etc.). For each freight operator of the fleet, the network computer system 100 can obtain availability information that includes (i) an availability status of the freight operator during one or more future time intervals, and (ii) available location information of the freight operator during the one or more future time interval.

With reference to an example of FIG. 1, booking and shipment order acquisition processes can be implemented by freight operator interface 102, monitor 110 and freight operator store 132. The freight operator interface 102 can include processes which communicate with a service application 46 executing on the freight operator device 40 of each freight operator associated with an account of the fleet manager. In examples, the network computer system 100 implements processes, shown by monitor 110, to obtain availability information 131 for each freight operator via the freight operator interfaces 102 and freight operator devices 40 of the freight operators. The monitor 110 can communicate with the respective service applications 46 executing on each freight operator device to trigger or otherwise cause the respective freight operator devices 40 to acquire and transmit freight operator availability information 131 to the network computer system 100.

The availability information 131 can include an availability status of the freight operator during one or more future time intervals, as well as available location information of the freight operator during one or more future time intervals coinciding with pickup times for newly assigned shipment orders. The availability status can include an indication as to whether the freight operator is available to haul a new shipment. Additionally, the availability status can also indicate a determination as to whether the freight vehicle operated by the freight operator has capacity to haul a new shipment. The available location information can include or be indicative of, for example, a current location of the freight operator, a planned or anticipated location of the freight operator during a future time interval, a current or future route of the freight operator, and/or a planned or future pickup or drop-off location for a shipment that the freight operator is currently carrying.

In examples, the service applications 46 can execute on respective freight operator devices 40 to obtain a default preference or indication of the freight operator with respect to receiving new shipments to haul during a future time interval. For example, each freight operator of the fleet can operate the respective freight operator device 40 to initiate the service application 46, and to use an interface provided through the service application 46 to specify their availability status for one or more upcoming time intervals. Each freight operator can also interact with service application 46 to specify additional availability information, such as the geographic region of availability for the freight operator (e.g., city or territory which is sufficiently close for the freight operator to accept new shipment orders), as well as the type and/or capacity of the freight vehicle that the freight operator is operating during an upcoming time interval. Thus, for example, each freight operator can control, via the respective service application 46, the availability status of the freight operator, as well as other availability information, such as the freight operator's geographic region of availability.

The service application 46 executing on each freight operator device 40 can also determine and communicate other availability information 131. Each service application 46 can, for example, repeatedly determine and communicate the current location of the freight operator by accessing geo-aware resources of the computing device, such as an internal satellite receiver (e.g., Global Positioning System (“GPS”)).The individual freight operator devices 40 may also execute the respective service applications 46 to access other types of data, such as sensor data obtained from an accelerometer, gyroscope, inertial mass unit (“IMU”) or other type of sensor device.

Still further, the service application 46 can also determine availability information 131 for the respective freight operator by analyzing current or past freight activities of the freight operator. For example, the service application 46 can maintain a log of lanes or routes the freight operator is currently fulfilling or has previously fulfilled. In an example, availability information can include a current route or lane of a shipment the freight operator is hauling. The freight operator interface 102 can communicate with the service application 46 of each freight operator to determine availability information 131 that includes, for example, a current route of the freight operator that is based on an in-progress shipping assignment of the freight operator. The freight operator interface 102 can also communicate with the service application 46 of each freight operator to determine availability information 131 that includes historical information and/or freight operator preferences (e.g., recent lanes driven by the freight operator, current backhaul or relay route for freight operator). In this way, the network computer system 100 can repeatedly obtain or determine availability information 131 that includes, for example, the current location of the freight operator, a location of the freight operator during a future time interval, a current or future route being driven by the freight operator, a backhaul or relay route for the freight operator, and/or a pickup or drop-off location for the current shipment order that is assigned to the freight operator.

The monitor 110 can structure and store availability information 131 of each freight operator with freight operator store 132. The freight operator store 132 stores a collection of freight operator records 134 to reflect the activities and availability of individual freight operators that are available for a given fleet. In examples, the monitor 110 can populate and update the freight operator records 134 of the freight operator store 132 for corresponding freight operators based on freight operator availability information 131 communicated by respective freight operator devices 40. For a given freight operator, monitor 110 can associate a freight operator identifier with a corresponding freight operator record 134, and then updates the respective freight operator record 134 with relevant availability information 131 transmitted from the corresponding freight operator device 40.

According to some examples, the respective freight operator record 134 can include freight operator parameters 135, which may be based on the availability information 131 of corresponding freight operators. The freight operator parameters 135 can include the current location of the freight operator, a planned or anticipated location of the freight operator during a future time interval, a current or future route of the freight operator, and/or a planned or future pickup or drop-off location for a shipment that the freight operator is currently carrying. In variations, the freight operator parameters 135 can include, for example, shipment parameters of one or more shipping orders that are currently assigned to the freight operator. As an addition or variation, the freight operator parameters 135 of individual freight operator record 134 can include (i) a type of freight vehicle the freight operator is currently operating, (ii) a current route or destination of the freight operator, (iii) a status of a current shipping assignment of the freight operator, (iv) a size, type or other characteristic about one or more loads which the freight operator is currently hauling, and/or (v) other relevant information for determining an availability of the freight operator based on current activities of the freight operator. The freight operator interface 102 can repeatedly communicate with the service applications 46 of freight operator devices 40 to update the availability information.

In some examples, each freight operator record 134 can also include freight operator parameters that reflect a scheduled or future shipping order that is assigned to the freight operator, where, for example, the pickup time of the scheduled shipping order is in or near a future time interval. In such examples, individual freight operator records 134 can include freight operator parameters 135 that reflect (i) a type of freight vehicle that the freight operator is expected to or may be able operate during the future time interval to fulfill the upcoming shipping order; (ii) a size, type or other characteristic of a load which the freight operator is assigned to haul; and/or (iii) an expected or planned route for the freight operator in connection with picking up and/or delivering a load of the future shipping order assigned to the freight operator.

As an addition or variation, the network computer system 100 maintains a profile store 125 to store freight operator profiles 145 for each freight operator of the fleet. The freight operator profiles 145 can identify, for example, preferences, tendencies, restrictions and/or historical information of corresponding freight operators. In some examples, the freight operator profiles 145 are updated based on input provided by respective freight operators. For example, the service applications 46 that run on the freight operator devices 40 may prompt freight operators to enter information about the freight operator's preferences, such as the times when the freight operator wishes to be active, the type of freight vehicle the freight operator wishes to operate, and/or the type or size of freight load the freight operator wishes to haul. The preferences may then be communicated to the network computer system 100 via the freight operator interface 102, and stored with the profile store 125.

Still further, in other variations, profiling logic may be implemented by the network computer system 100 to record and analyze the parametric information stored with the freight operator records 134 of the individual freight operators. For a given freight operator, the profiling logic may analyze the freight operator records 134 to determine, for example, route preferences and/or optimizations for freight operators. For example, the profiling logic can determine route optimizations, based on current or scheduled assignments of the freight operator. By way of example, the route optimizations can identify backhaul or relay routes for the individual freight operators, based on current or scheduled assignments of the respective freight operators.

As an addition or variation, the service application 46 can maintain the profile store 125 on the freight operator device 40 for the respective freight operator. In turn, the service application 46 can communicate updated preferences for the respective freight operator to the network computer system 100.

Freight Operator Matching and Assignment

In examples, the network computer system 100 also implements processes to (i) match freight operators of a fleet with shipment requests, and (ii) assign available freight operators to shipment requests which are available to or booked by the fleet. With reference to an example of FIG. 1, freight operator matching and assignment processes can be implemented by fleet manager component 116, matching engine 120 and assignment component 124. The fleet manager component 116 can provide a fleet management user-interface 118 that includes, for example, one or more multiple panels that provide a fleet manager with information and interactive tools, to facilitate a fleet manager in managing bookings, assignment of freight operators and other tasks.

In examples, a fleet manager may access and use the fleet management service by using a fleet manager interface 106 (e.g., web portal, service application, etc.) to interact with the fleet management user-interface 118. The fleet manager can use, for example, a browser to access a web portal over the Internet, or a mobile device to execute a fleet manager service application that is configured to access and communicate with the network computer system 100. In this way, the fleet manager can interact with the fleet management user-interface 118 to view information about open shipment orders, view information about available freight operators, book selected shipment orders, view matchings of freight operator to booked or open shipment order, and assign booked shipment orders to available freight operators. In one implementation, the fleet manager component 116 can access the shipment store 112 to retrieve information about open or booked shipment orders, and to provide aggregated shipment information as part of the fleet management user-interface 118. The fleet manager component 116 can also generate the fleet management user-interface 118 to display shipment information based on one or more criteria, such as geographic region, status, etc. The fleet manager component 116 can further provide one or more interactive features to enable the fleet manager to specify search criteria for identifying shipment orders (e.g., open shipment orders in a given geographic region, or which exceed a specified amount of value). Additionally, the fleet manager component 116 can include one or more features to enable the fleet manager to interact with the fleet management user-interface 118 to book select open shipment orders, as identified by corresponding shipment records 114 of the shipment store 112.

Likewise, examples provide for the fleet manager component 116 to include processes that retrieve information about freight operators from the freight operator store 132. The retrieved information can be displayed with the fleet management user-interface 118 to identify the availability status of individual freight operators, as well as available location information for individual freight operators.

In some examples, the fleet manager component 116 can respond to input provided by the fleet manager (e.g., via the fleet management user-interface 118) to initiate processes of one or more fleet management workflows. For example, the fleet manager can interact with the fleet management user-interface 118 to trigger the matching engine 120 in determining matchings as between open or booked shipment orders and available freight operators of the fleet. Furthermore, the fleet manager can interact with the fleet management user-interface 118 to confirm matchings, reject matchings, or alter matchings (e.g., select alternative available freight operator for booked shipment order). When matchings are confirmed, the assignment component 124 can send a notification to the freight operator device 40 about an assigned shipment order.

In some examples, the fleet manager provides input using the fleet management user-interface 118, and in response, the fleet manager component 116 initiates one or more processes of the fleet management workflow. In particular, the fleet manager component 116 can initiate processes for shipment order acquisition and booking, freight operator availability information, and/or matching and freight assignment. In variations, some or all of the fleet management workflow can be implemented automatically, such as in accordance with a predetermined schedule or in response to an external signal. By way of example, the shipment order acquisition and freight operator availability determination processes can be performed repeatedly and automatically, and the fleet manager can access the fleet management user-interface 118 to initiate processes for booking select open shipment orders and/or matching of freight operators to select shipment orders.

According to some examples, the matching engine 120 implements (i) a preliminary matching process to match available freight operators of the fleet with open shipment orders that satisfy freight operator or fleet manager matching criteria, and (ii) another matching process to match booked shipment orders with one or more available freight operators of the fleet. In variations, the matching engine 120 may implement an additional or alternative preliminary matching process, where open shipment orders are matched to available freight operators based at least in part on matching criteria that is specific to the open shipment orders.

In implementing a matching process, the matching engine 120 accesses the shipment store 112 to obtain shipment parameters 113 of the corresponding open shipment orders. The matching engine 120 uses the parametric values of the shipment records 114 to generate match criteria 115 for the open shipment orders. By way of example, the parametric values of a given shipment order can include pickup location, pickup time or window, size of load, specified type of freight vehicle or trailer, drop-off location. The matching engine 120 can further use rules or other logic to determine match criteria 115 based on the parametric values associated with individual shipment orders. For example, the matching engine 120 can include logic that identifies a threshold proximity to a pickup location of a shipment order. By way of example, the match criteria 115 can determine the threshold proximity to be a given distance (e.g., 100 miles or kilometers) or driving time (e.g., 2 hours) from a pickup location, based on the freight operator's current location or the freight operator's expected location in a future time interval.

In an example of FIG. 1, each freight operator record 134 of the freight operator store 132 may represent a corresponding freight operator of a corresponding fleet. Each freight operator record 134 may also include freight operator parameters 135 that are based on the determined availability information 131 for the corresponding freight operator.

In some examples, the matching engine 120 queries freight operator store 132 to identify freight operator records 134 that satisfy the match criteria 115 of each booked order. Additionally, the matching engine 120 can limit the query to those freight operator records 134 which indicate an availability status of being available during the relevant time interval of a corresponding shipment order. Based on implementation, the matching engine 120 can A) identify a subset of available freight operators used by the fleet, by identifying freight operator records 134 which indicate a corresponding freight operator as being availability during a future time interval that precedes or encompasses the pickup time or window for the corresponding shipment order, and B) from the subset, identify (i) freight operator records 134 that reflect a current location of a corresponding freight operator as being within a threshold distance of the pickup location, and/or (ii) freight operator records 134 that reflect an expected location of a corresponding freight operator during the future time interval as being within a threshold distance of the pickup location example. In this way, the matching engine 120 can use the availability status and available location information 131 of individual freight operators to match freight operators to shipment orders.

In examples, the matching engine 120 can query the freight operator store 132 to retrieve freight operator records 134 having freight operator parameters 135 that satisfy or match to the match criteria 115. In this way, the matching engine 120 generates, for booked or open shipment order, a result set 129 that identifies a set of matching freight operator records 134 that satisfy the match criteria 115 of a corresponding shipment order. In examples, the result set 129 is determined for booked shipment orders. In variations, the result set 129 identifies a subset of all matching freight operator records 134 for each open shipment order, where the subset is determined based on a determination of those operator records which are the best matches for the open shipment order.

In examples, the fleet management component 116 can use the result set 129 for booked shipment orders, as determined by the booking engine 122, to generate one or more types of preview panels 138 (e.g., booking preview panel, assignment preview panel) as part of the fleet management user-interface 118. For example, the matching engine 120 can retrieve or filter the shipment records 114 of the shipment store 112 for shipment orders that have been booked for the account of the fleet manager. In an example, the preview panel 138 includes a data structure that lists the booked shipment orders of the fleet manager, with each shipment order being displayed in association with an identifier of an available freight operator of the fleet. In variations, the preview panel 138 displays an identifier of each open or booked shipment order with an identifier of the available freight operator that is deemed to be the best match. For each open or booked shipment order, the matching engine 120 determines (i) a set of freight operators that satisfy the matching criteria 115, and (ii) ranks each matched freight operator based on one or more optimization parameters. In examples, the optimization parameters are based on select availability parameters. For example, the optimization parameter can reflect a proximity of the freight operator to a pickup location of a booked or open shipment order. Further, the proximity determination can be made for an upcoming or future time interval, reflecting a pickup window for the open shipment order. In such examples, the proximity determination can be based on freight operator parameters 135, including the current location of the freight operator, the route of the freight operator, the next stop of the freight operator, and/or an expected location of the freight operator during the future time interval.

Still further, in other variations, the preview panel 138 (e.g., assignment preview panel) can display multiple booked shipment orders, each of which are displayed in association with the respective identifiers of one or more freight operators who satisfy the matching criteria for the respective shipment order. The preview panel 138 can include an input feature to enable the fleet manager to confirm each of the displayed matchings. In variations, the preview panel 138 can also include an input feature to enable the freight operator to select one of multiple matched freight operators. Still further, the preview panel can include an input feature to enable the freight operator to select a different freight operator than the one that is displayed as being a best match (e.g., based on criteria to reduce deadhead driving). The preview panel 138 can further include functional elements to enable the fleet manager to confirm freight operators are to be assigned to matched shipment requests. As described with other examples, the functional elements can cause the fleet manager component 116 to trigger the assignment component 124 to send a notification to the respective freight operator.

Still further, in some examples, the preview panel 138 can display open shipment orders in association with one or more matched freight operators. For example, the matching engine 120 can determine match criteria 115 for one or more open shipment orders, and identify one (e.g., best match) or multiple freight operators that satisfy the match criteria 115 based on the respective freight operator parameters 135 of each freight operator. The preview panel 138 can display the result set 129, such that the fleet manager is able to view open shipment orders (as determined from shipment records 114) in association with identifiers of matched freight operators. In such examples, the preview panel 138 can include functional elements with each open shipment order, where the functional elements are responsive to the fleet manager input to initiate a process to book one or multiple open shipment orders. In this way, the preview panel 138 enables a fleet manager to (i) select an open shipment order to book, while viewing information that enables the fleet manager to view or select freight operators that are available for that shipment order; and/or (ii) view and book multiple open shipment orders at one time, or from the same preview panel 138, while viewing available freight operators for each of the shipment orders.

In examples, a fleet manager can interact with a preview panel 138 (e.g., booking preview panel) of the fleet management user-interface 118 to confirm or otherwise determine matching freight operators for one or multiple booked shipment orders. Once confirmation is provided by the fleet manager, the assignment component 124 can notify the matched freight operator to each booked shipment request. The assignment component 124 can generate a notification 117 for each matched freight operator of the preview panel 138. In examples, the notification 117 can be communicated as a push notification that is communicated to a corresponding freight operator device 40, to inform the freight operator of an assigned shipment request. Accordingly, the notification 117 can include or link to information about the shipment order that is assigned to the freight operator, such as the pickup location and/or drop-off location, as well as the service value of the shipment.

In some examples, freight operator can do nothing to accept the assignment, and after a default time period (e.g., 30 minutes) has passed, the freight operator is deemed to accept the shipment request. In some variations, the freight operator can respond to the notification 117 by rejecting the shipment request. For example, the freight operator can reject a matched shipment order via the service application 46 executing on the freight operator device. The fleet manager component 116 can detect the reply communication from the freight operator, and trigger the matching engine 120 to determine a new matching for the booked shipment order that was rejected. In examples, the fleet manager component 116 can generate an alert for the account of the fleet manager to signal the fleet manager that a booked shipment request is not yet assigned. The alert can, for example, be communicated to the fleet manager as a notification or message, via a device or account interface or through a third-party communication medium. The fleet manager can interact with the preview panel 138 to identify a different freight operator for assignment to that shipment order.

According to some aspects, the fleet management component 116 can generate the booking preview panel 138 to include one or more markers that are indicative of the ability of the fleet's freight resources to fulfill an identified open shipment order. In examples, the fleet management component 116 can analyze the result set 129 for a given open shipment order to determine a number of matching freight operators—meaning freight operators which are available to fulfill the shipment order. In such examples, the fleet management component 116 may generate the preview panel 138 to include a quantitative marker that identifies, for example, the number of freight operators that are available to the fleet manager to handle the open shipment order. In variations, the quantitative marker may indicate the amount of freight resources the fleet manager has available by a degree, level or category (e.g., ‘low’, ‘medium’, or ‘good’). The fleet management component 116 may generate the preview panel 138 to reflect a structured data set that identifies multiple open shipment orders in association with (i) a corresponding marker reflecting the fleet manager's freight resources for handling the open shipment order, and/or (ii) a booking element that enables the fleet manager to provide a booking input 123. The fleet management component 116 can utilize active data elements to embed the association of matching freight operator records 134 with each of the identified shipment orders. The fleet manager can select an active element to cause the fleet management component 116 to display, as part of the fleet management user-interface 118, additional information for a corresponding operator record 134 that is identified by the selected element.

In variations, the network computer system 100 implements one or more matching processes by categorizing available freight operators for individual shipping orders. The network computer system 100 can define one or more categorical designations that are based at least in part on a comparison of delivery parameters for a freight operator's current (or upcoming, when relevant) shipping assignment and the delivery location of the new or unassigned shipping request. Still further, the network computer system 100 can define one or more categorical designations that are based at least in part on comparisons of the loading location and/or delivery location of the freight operator's current assignment, and the shipment parameters of the new or unassigned shipping order. As an addition or variation, the network computer system 100 can define one or more categorical designations that are based at least in part on an aggregate analysis of the freight operator's prior assignments. The categorical designations may include backhaul designations (e.g., freight operator has return shipping route that is reverse of the current assignment), as well as relay designations (e.g., destination of current assignment can be pickup location for upcoming assignment).

In some examples, the matching engine 120 can prioritize categorical designations for matching processes, such that freight operators satisfy a particular categorical designation are weighted or favored to match to a corresponding shipping order. In this manner, the categorical designations can be used to promote objectives of (i) reducing the distance and/or duration of travel for freight vehicles in between carrying loads, and/or (ii) increasing the instances when freight operators are matched to a shipping order that matches a preference or promotes an objective of the fleet manager.

In variations, the matching engine 120 can implement the matching processes for open and booked shipping orders at one time, so as to generate result data sets for open shipment orders and booked shipment orders at one time. The fleet management component 116 may receive the combined result data set and further use filters to identify result sets for the respective preview and assignment panels.

Methodology

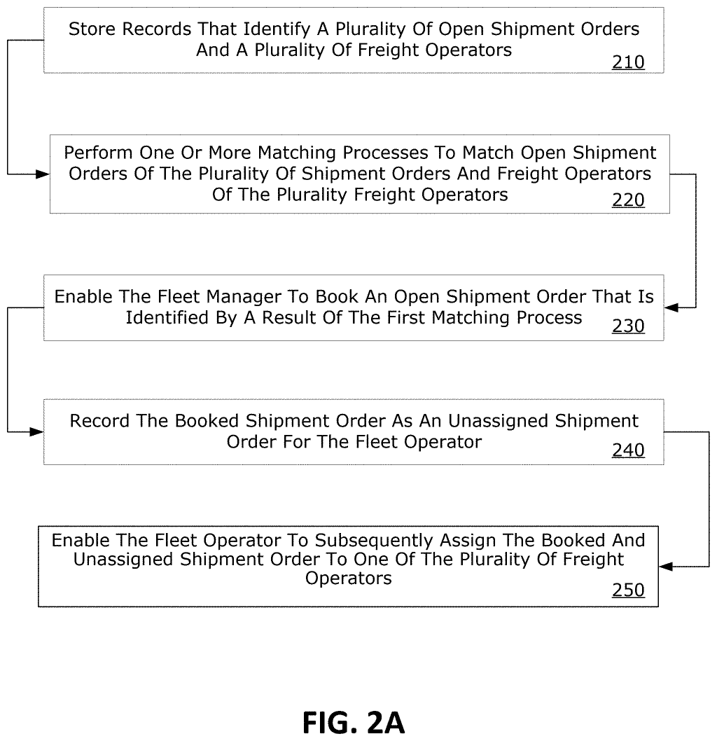

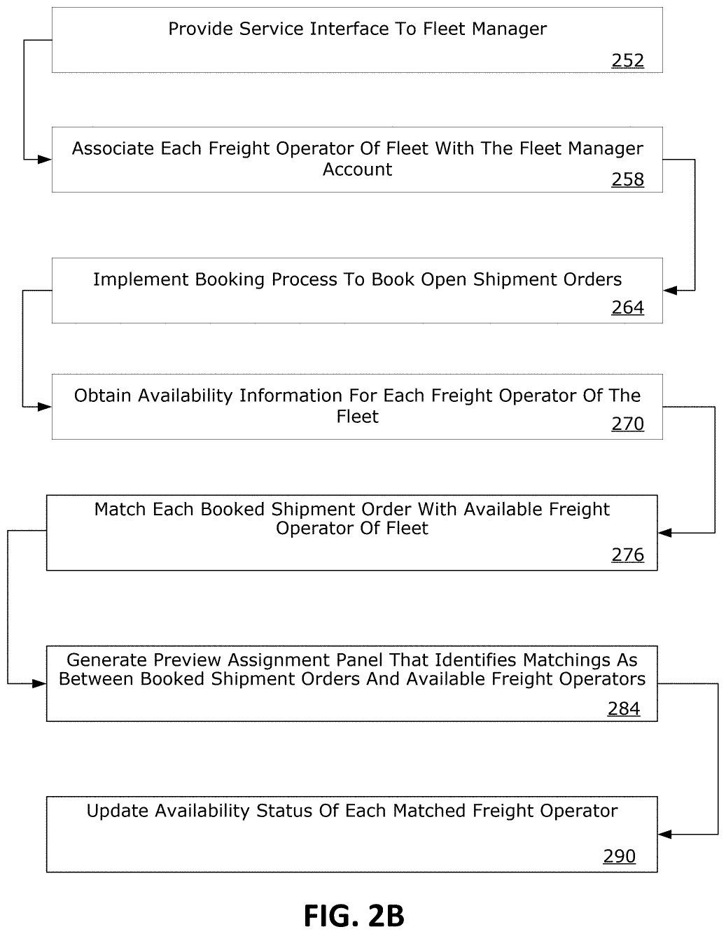

FIG. 2A and FIG. 2B illustrate example methods for providing a fleet management service. According to examples, example methods such as described with FIG. 2A and FIG. 2B may be implemented using a network computer system such as described with examples of FIG. 1. Accordingly, in describing example methods of FIG. 2A and FIG. 2B, reference may be made to elements of FIG. 1 for purpose of illustrating suitable components and functionality for performing a step or sub-step being described.

With reference to FIG. 2A, network computer system 100 stores a plurality of records, where the plurality of records identify a plurality of open shipment orders and a plurality of freight operators (210). The record for each of the plurality of open shipment orders can further identify a set of shipment parameters for that open shipment order. Additionally, the record for each freight operator of the fleet can include availability information 131, including the availability status of the freight operator for one or more future time intervals, and available location information for each freight operator. In some examples, the availability information 131 can be determined from freight operator input. For example, each freight operator can interact with one or more interfaces generated by service application 46 on the freight operator's device 40, to specify (i) the freight operator's availability during one or more future time intervals, (ii) the capacity of the freight operator's trailer to haul shipments of a particular size or type, (iii) a type of freight vehicle the freight operator is operating in available time intervals, and/or (iv) location information identifying one or more future locations of the freight operator. To illustrate, the location information that identifies one or more future locations of the freight operator can include a pickup or drop-off location for a shipment the freight operator is hauling, an expected location of the freight operator, a route or lane the freight operator is currently operating on, and/or a geographic region (e.g., portion of a state) that the freight operator identifies as being available to the freight operator).

In variations, some or all of the availability information 131 can be programmatically determined based on, for example, information stored on the freight operator device, such as (i) location, route or lane preferences of the freight operator, and/or (ii) logs or other records of current, most recent or prior freight activity of the freight operator. The service application 46 can communicate such availability information 131 to the network computer system 100. Alternatively, the service application 46 can communicate raw data (e.g., history of shipment orders and location) from which the available location information can be determined.

In examples, the network computer system 100 performs a freight matching process to match open shipment orders of the plurality of shipment orders and freight operators of the plurality freight operators (220). In examples, the one or more matching processes are performed using at least the set of shipment parameters 113 identified by the shipment record 114 of each open shipment order of the plurality of open shipment orders, as well as freight operator parameters 135 provided with each freight operator record 134, reflecting availability information 131 (e.g., freight activity information) of each freight operator of the plurality of freight operators.

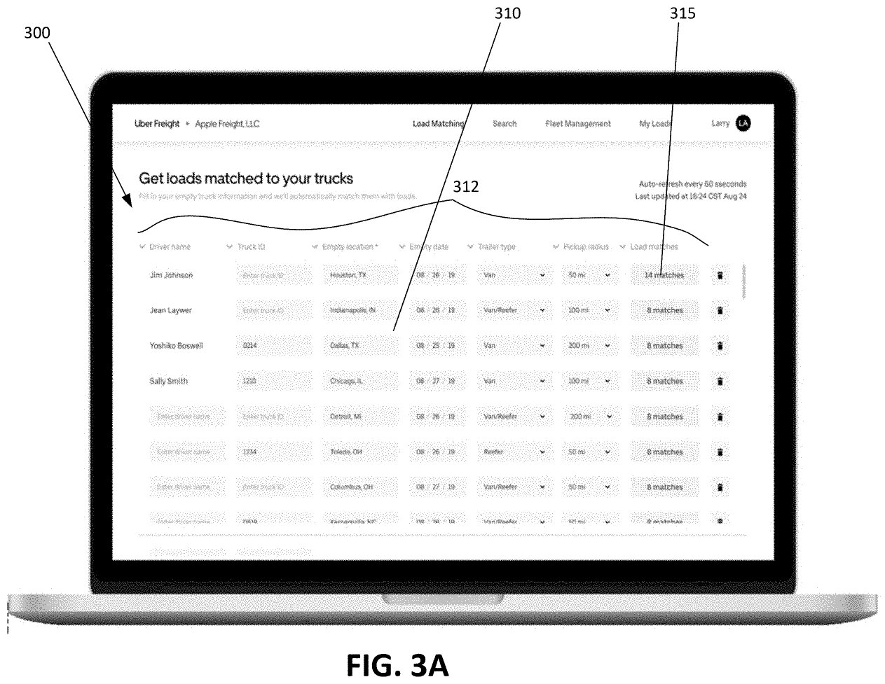

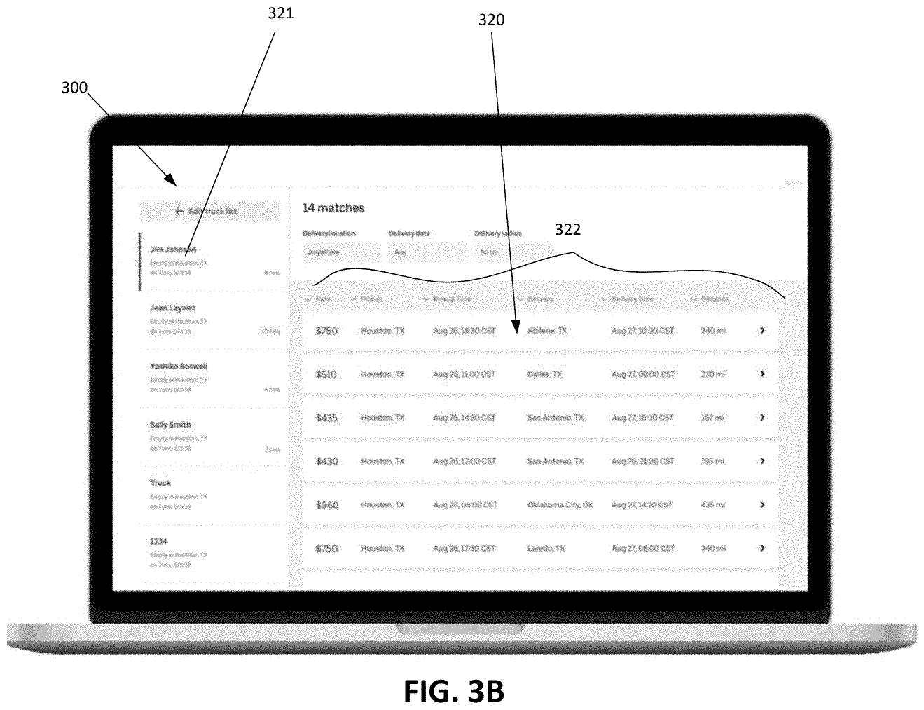

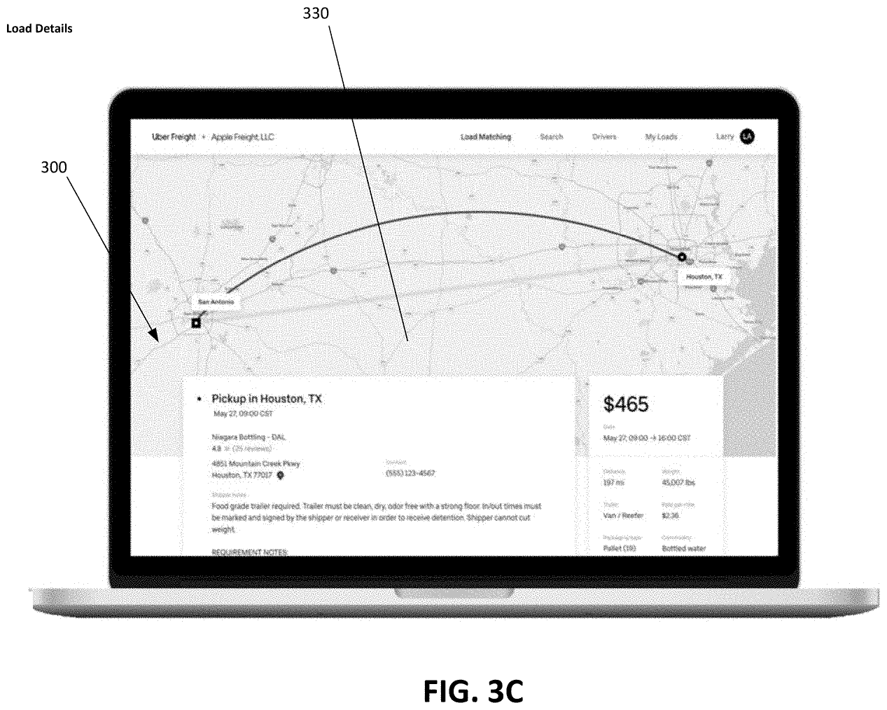

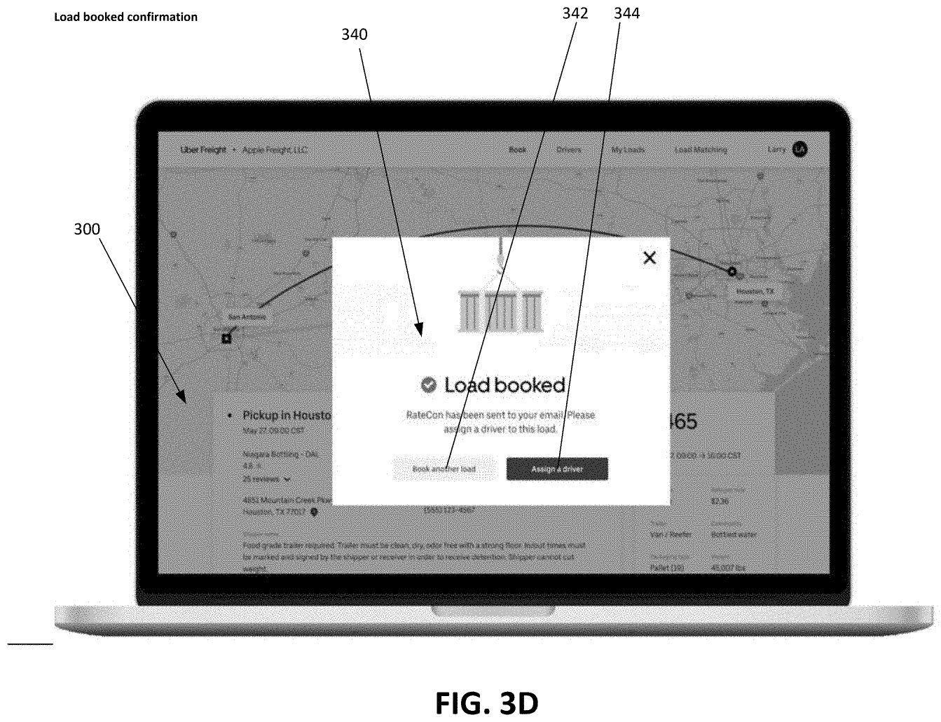

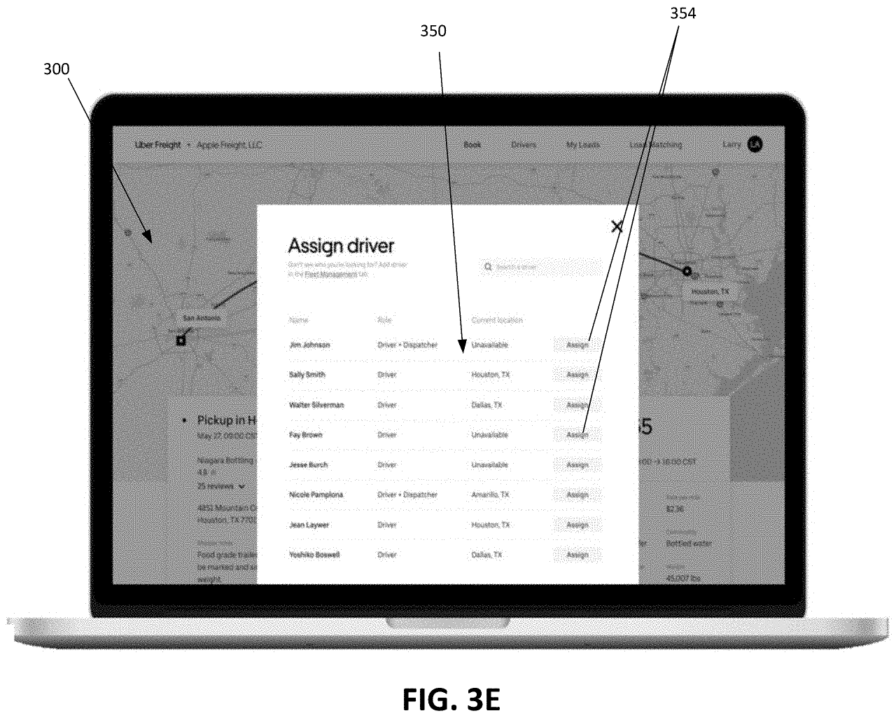

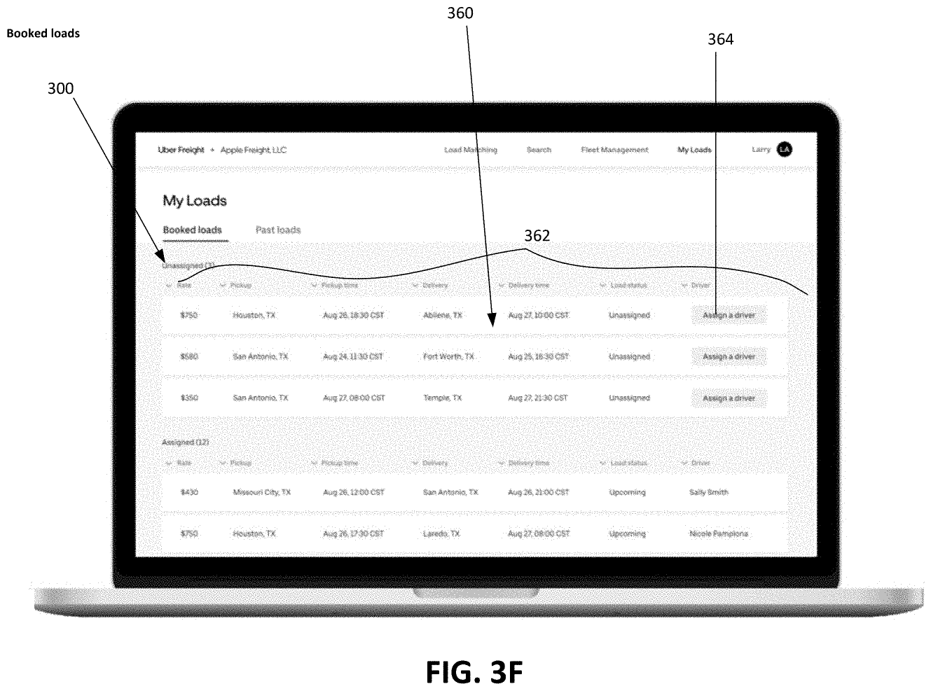

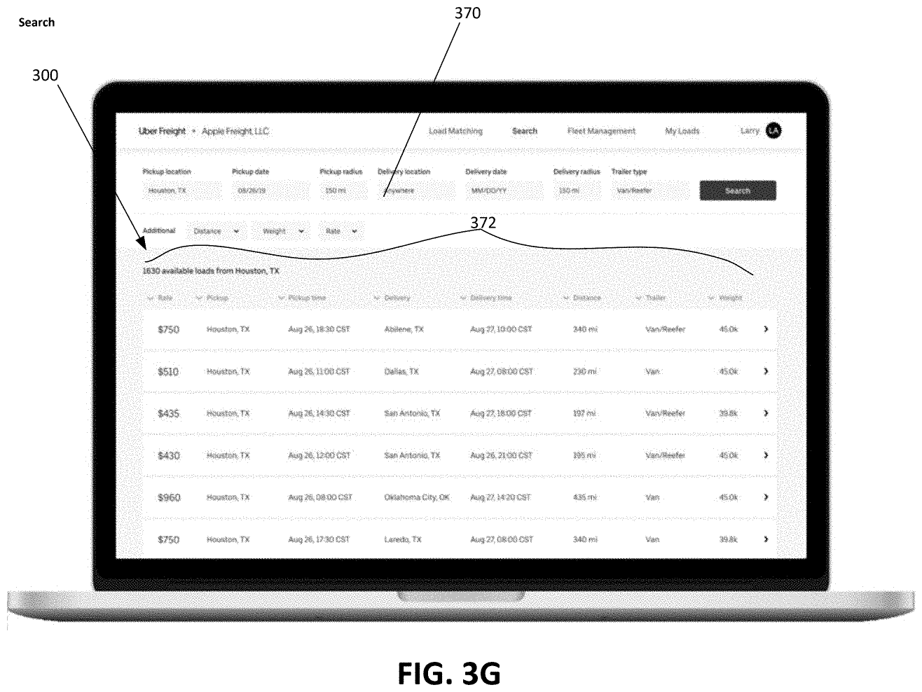

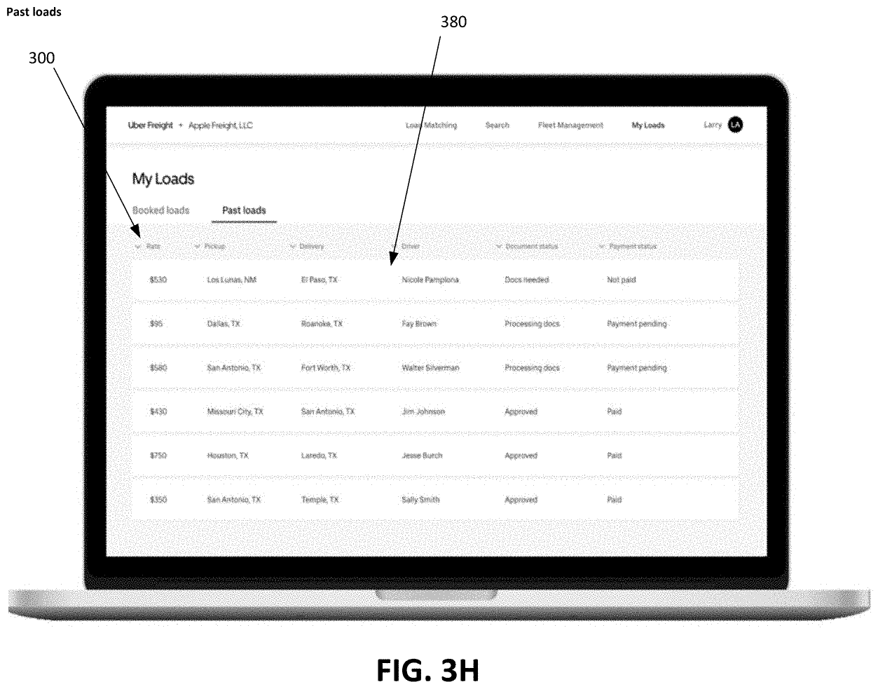

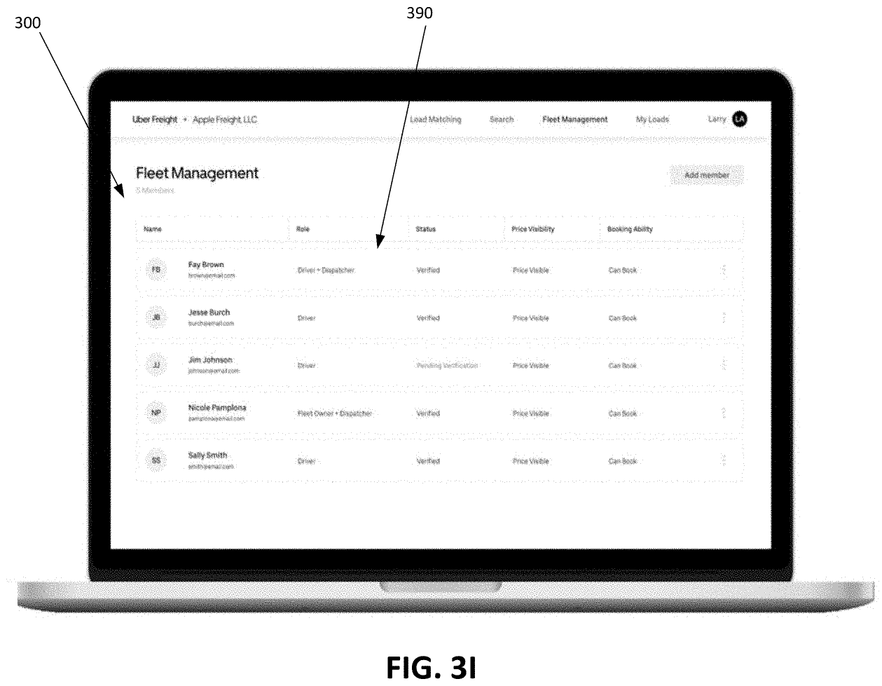

In examples, the network computer system 100 enables the fleet manager to book an open shipment order that is identified by a result of the freight matching process (230). The fleet manager can book the open shipment order without assigning the booked shipment order to any freight operator of the plurality of freight operators. For example, the network computer system 100 may generate a fleet management user-interface 118, such as described with any of the examples of FIG. 1 or FIG. 3A through FIG. 3I. On the fleet management user-interface, the network computer system 100 can integrate an interactive element that is selectable by the fleet manager to trigger a booking process to access a shipper resource (e.g., third-party) and book the open shipment order identified by the fleet manager input.

The network computer system may further record the booked shipment order as an unassigned shipment order for the fleet manager (240). Additionally, the network computer system 100 can enable the fleet manager to subsequently assign the booked and unassigned shipment order to one of the plurality of freight operators (250). For example, the fleet manager may interact with the fleet management user-interface to initiate a matching process that is implemented by the matching engine 120. The matching process can identify candidate freight operators for a booked and unassigned shipment order. Based on the matching process, the freight operator may provide input to assign a selected freight operator to the booked/unassigned shipment order.

With reference to an example of FIG. 2B, the network computer system 100 operates to provide a service interface to a fleet manager, where the service interface is associated with an account of the fleet manager (252). For example, a fleet manager can register and subsequently access an account with a web portal that is provided by the network computer system 100. As an addition or variation, the network computer system 100 can provide account interface through a specialized service application that is installed and executed on a mobile device of the fleet manager.

In examples, the network computer system 100 operates to associate each freight operator of multiple freight operators with the account of the fleet manager (258). In some examples, freight operators can install a specialized service application 46 on their respective freight operator device 40, then operate a service application feature to link the activity of the freight operator to the account of the fleet manager.

In variations, the freight operator may be linked to multiple accounts, each being associated with a different fleet manager. The freight operators can interact with the service applications 46 to reflect their availability for the particular fleet of the fleet manager. In such variations, independent freight operators can, at the freight operator's option, intermittingly comprise a resource of a given fleet manager and account.

In examples, the network computer system implements a booking process to book open shipments (264). In some examples, the booking process includes identifying fleet booking criteria for the account of the fleet manager, accessing a listing of open shipment orders, where each open shipment order of the listing is associated with a set of shipment parameters, identifying a set of one or more open shipment orders of the listing which satisfy the fleet booking criteria, and performing one or more booking operations to book multiple shipment orders of the set with the account of the fleet manager.

The network computer system further obtains availability information for each of the plurality of freight operators that are associated with the fleet manager account (270). In examples, the availability information includes (i) an availability status of the freight operator during one or more future time intervals, and (ii) available location information of the freight operator during the one or more future time intervals.

The network computer system can further match each of the multiple booked shipment orders with one of the freight operators of the plurality of freight operators based on the availability information (276). The matched freight operator can further be selected based on a determination that the freight operator optimizes one or more objectives of the fleet. For example, the availability information 131 of each freight operator can be compared to select shipment parameters to identify an optimal available freight operator for each booked shipment order. In examples, the determination can be based on, for example, a proximity of the freight operator to the pickup location of the booked shipment order, given the respective freight operator's current location, expected future location, planned stops (e.g., next drop-off location for shipment being carried), route, etc.

In examples, the network computer system generates a preview panel 138 through the account interface of the fleet manager to identify multiple matchings (284). By way of example, a preview panel can be generated such as shown by an example of FIG. 3E. The preview panel 138 can be interactive to enable the fleet manager to provide input to confirm or alter any of the multiple matchings. In examples, the preview panel 138 enables the fleet manager to accept, reject or modify each of the identified matchings.

The interaction between the fleet manager and the preview panel can generate an output that can include updating an account or status of the identified freight operator (290). As an addition or variation, an output generated by the fleet manager's interaction with preview panel 138 can cause the network computer system 100 to send a notification to the device 40 of the freight operator identified by the matching. The notification can, for example, inform the freight operator of the matching, as well as information about the matched shipment order. In examples, the freight operator can interact with the notification to send a reply communication. For example, the freight operator can interact with the notification to send a reply communication that accepts or rejects an assigned shipment. In some examples, the freight operator can take no action to accept the assignment of the matched shipment order. By implementing a communication protocol in which the freight operator specifies his or her likely acceptance by default to an assigned shipment order, examples eliminate efficiencies present with some conventional approaches, where fleet managers and freight operators exchange communications over an extended time interval to determine whether the freight operator accepts or rejects an assigned shipment order.

In an example, each matching of the preview panel identifies a booked shipping order and one or multiple freight operators which are available for that shipment order. In such examples, when matchings are confirmed by the fleet manager, a notification is sent to the individual freight operators of the fleet.

In variations, the matchings of the preview panel 138 can identify booked or open shipment orders (which have not been booked), and indicators of available freight resources for the fleet manager to fulfill the shipment order. In examples, the indicators of available freight resources include quantitative markers (e.g., number of freight operators who are available to fulfill the particular shipment order), identifiers of freight operators who satisfy one or more criteria for fulfilling the shipment order, and/or an identifier of an available freight operator that is deemed to be an optimal match for the shipment order.

Example Freight Management User-Interface

FIG. 3A though FIG. 3I illustrate different aspects of a freight management user-interface, according to one or more examples. A freight management user-interface 300, as described by examples of FIG. 3A through FIG. 3I, may be generated by a network computer system 100 such as described with examples of FIG. 1. Accordingly, freight management user-interface 300 provides an example of freight management user-interface 118, as generated by fleet management component 116, and as illustrated and described by examples of FIG. 1. In describing examples, reference may be made to elements of FIG. 1 for purpose of describing components or functionality in context of the example freight management user-interface 300.

In an example of FIG. 3A, the freight management user-interface 300 is shown to include a freight operator matching panel 310. The freight operator matching panel 310 can list multiple available freight operators of the fleet, with each listed freight operator being associated with a set of matching open shipment orders. For each freight operator, the determination of the set of matching open shipment orders (e.g., ‘matching loads’) can be made by, for example, matching engine 120, using shipment records 114 of the shipment store 112 to determine shipping criteria 115, and freight operator records 134 of the freight operator store 132 to determine freight operator parameters 135.

In examples, the freight operator matching panel 310 lists available freight operators of the fleet. In an implementation, the matching engine 120 can identify, from freight operator records 134, a state status field that reflects the freight operator being available in a given time interval under consideration (e.g., current time interval, future time interval).

As an addition or variation, the matching engine 120 can utilize the freight operator parameters 135 of the freight operator record 134 for each available freight operator to determine matching criteria that is specific to that freight operator. For each available freight operator, the matching engine 120 can use the corresponding matching criteria to query the shipment store 112 for shipment records 114 of open shipment orders, that satisfy the specific matching criteria of the respective freight operator. In examples, the matching engine 120 generates multiple result sets, with each result set identifying a freight operator and information about open shipment orders that satisfy matching criteria for that freight operator. The matching engine 120 implements the matching process for each freight operator that is determined to be available in an upcoming or future time interval, using matching criteria that is specific to the particular freight operator. In this way, the freight operator matching panel 310 can list multiple available freight operators at one time, with each listed freight operator being associated with a set of matched open shipment orders.

In an example, freight operator matching panel 310 can be structured as a table 312 where each entry (e.g., row) identifies a freight operator and/or freight vehicle that is determined to be available over a given time interval under consideration. The entry for each freight operator and/or vehicle may further identify values that correspond to or are otherwise determined from the freight operator parameters 135 of the corresponding freight operator record 134. In an aspect, each available freight operator may be associated with parametric values that include, for example, a location where the freight operator is expected to become empty (“empty location”), and a date when a freight operator is expected to be available (“truck empty date”). In some examples, the empty location may be determined from the destination of the freight operator's current load, and the truck empty date may be determined from the expected delivery time of the freight operator's current load. The empty location/date information may be provided from, for example, shipment parameters 113 of the shipment order which the freight operator is currently operating. In variations, the empty location/date information may reflect updates that are determined by monitor 110. For example, the monitor 110 can implement processes to track the progress of the freight operator in fulfilling a current shipment order based on, for example, the recorded location of the freight operator and the observed or expected route of the freight operator.

Additionally, in another aspect, the entry for the freight operator and/or freight vehicle may be associated with parameters that are determined from, for example, the profile 145 of the freight operator. For example, the profile 145 of each freight operator may record historical information, such as a type of vehicle the freight operator is operating. Additionally, the profile 145 may reflect one or more preferences or restrictions of the freight operator, such as a preference/restriction of the freight operator as to a pickup radius (e.g., distance freight operator is willing to drive from a planned route or from a delivery location to pickup a shipment).

Additionally, in examples, the freight operator matching panel 310 may associate a quantitative or numeric marker 315 with each freight operator, where the marker 315 identifies or otherwise indicates a number of open shipment orders that are matches for that represented freight operator. The marker 315 can reflect, for example, an ease by which the particular freight operator can be assigned an open shipment order, when considering, for example, possible variations in the respective freight operator's schedule as to delivery time and/or the freight operator's willingness to accept a new shipping assignment.

In an example of FIG. 3A, the marker 315 for each freight operator may reflect an embedded or linked element that associates the freight operator with a set of open shipment orders. In an example shown, the marker 315 is selectable by the end-user (e.g., fleet manager) to display more detailed information about the open shipment orders that are matched to each of the listed freight operators.

FIG. 3B illustrates an open shipment order panel 320 (or booking preview panel) for fleet management user-interface 300. The preview panel 320 may generate a list of open shipment orders that are determined to match to each available freight operator. The preview panel 320 can include a table 322 that lists the matched open shipment orders for each freight operator, as referenced by a corresponding freight operator identifier 321. The preview panel 320 can be displayed in response to the fleet manager selecting, for example, the marker 315 (see FIG. 3A) for one of the freight operators. When the marker 315 is selected, examples provide for the fleet management component 116 to generate the open shipment orders that match to selected freight operator. The available freight operators can be indicated by corresponding freight operator identifiers 321, with the identifier 321 of the selected freight operator being highlighted or otherwise shown in prominence with respect to the identifiers of other freight operators that are deemed available in the given fleet. The fleet manager may scroll through the identifiers 321 to display information about the matching open shipment orders of that freight operator.

In examples, each row of table 322 may be populated with parametric values that correspond to, or are otherwise based on shipment parameters 113 of a corresponding open shipment order that is matched to the selected freight operator. For example, each open shipment order listed in the table 322 may be associated with shipment parameters 113 corresponding to a pickup location, a pickup time interval, a delivery location, and a deadhead distance. In examples, the deadhead distance reflects the total distance the freight operator may have to travel from an existing or planned route, or from delivery location of current shipment, to reach the pickup location of the open shipment order.

In some examples, the fleet manager can interact with the preview panel 320 to identify open shipment orders as entries of the table 322, and to book select open shipment orders. In booking open shipment orders, the fleet manager can view information about the shipment order, as well as information about candidate or available freight operators for the shipment order.

FIG. 3C illustrates a booking information panel for fleet management user-interface 300. The booking information panel 330 can be generated in response to, for example, input provided by the fleet manager with respect to another of the panels of the fleet manager user-interface 300. In examples, the booking information panel 330 may be generated for open shipment orders, using parametric information provided by or with the shipment orders, including pickup or destination locations, timing parameters and price offered for completing the shipping order. In variations, the shipment interface 104 may receive or otherwise retrieve additional information about shipment orders from shipper's resources, and the additional parametric information may be stored with the shipment record 114 of the selected shipment order. By way of example, the additional parametric information may identify the shipper, a rating for the shipper (e.g., rating provided by freight operators), a map or other visualization of the pickup and destination locations for the open shipment order, and long text that specifies information about the shipment or other important information that the fleet manager may consider before booking the shipment. In some variations, the booking information panel 330 can be displayed for open shipment orders which the fleet manager wishes to review before booking.

In FIG. 3D, the freight management user-interface 300 generates a booking confirmation panel 340 that confirms the identified open shipment order was booked by the fleet manager. In examples, the confirmation may be determined programmatically, by, for example, the booking engine 330 accessing and communicating with the shipper via the shipment interface 104.

In examples, the booking confirmation panel 340 may also provide the fleet manager with one or more follow-on action features, once confirmation is received that a selected open shipment order has been booked. The booking confirmation 340 may allow the freight operator to choose a follow-on action to booking the selected open shipment order. In examples, the booking confirmation panel 340 may include a feature 342 to allow the freight operator to select another open shipment order for booking, without having to assign or identify the freight operator in advance. Additionally, the booking confirmation panel 340 may include an assignment feature 344 which allows the fleet manager to assign the booked open shipment order to one of the available freight operators. In some examples, the selection of assignment feature 344 generates one or more freight operators of the fleet who are predetermined to be a match to the booked shipment order. For example, the matching engine 120 can select which available freight operator of the fleet to match to the booked shipment request, based on proximity or other criteria that are deemed to optimize an objective (e.g., reduction in deadhead driving by freight operators of fleet) for the fleet. In variations, selection of the assignment feature 344 can generate a list of freight operators who match to the shipment request, from which the fleet manager can make an additional selection for assignment. In some variations, the list of freight operators who match the particular shipment order can be ranked by the matching engine 120 based on, for example, the one or more matching criteria (e.g., by proximity).

FIG. 3E illustrates an assignment preview panel 350 for an example fleet management user-interface. The assignment preview panel 350 can display the result set 129 that matches available freight operators of the fleet with booked shipment orders of the fleet. The matching engine 120 can, for example, identify shipping criteria 115 for the booked shipment orders, based on the shipment parameters of each of the booked shipment orders. The matching engine 120 can further access the freight operator data store 134 to identify availability parameters for freight operators of the fleet. As described with other examples, the matching engine 120 can identify freight operators which are available during a future time interval, as well as location available information for the freight operators. The matching engine 120 can perform the matching by identifying which freight operators satisfy the shipping criteria 115 for each booked shipping order. As an addition or variation, the matching engine 120 can, for each booked shipment order, select the freight operator that best matches the booked shipment order. The best match can correspond to, for example, the freight operator which is deemed to have the least deadhead driving (e.g., closest) to pickup the freight operator.

The assignment preview panel 350 can display multiple matchings at one time (booked shipping orders to available freight operators), and each matching can be displayed with an assignment feature 354. In this way, the preview panel 350 enables the fleet manager to assign shipment orders to freight operators in batch. As shown by examples, the fleet manager can confirm a matching of the assignment preview panel 350 by selecting the assignment feature 354. In examples, the when the assignment feature is selected, a notification is generated and sent to the matched freight operator. The notification can inform the freight operator of the booked shipment order that is assigned to the freight operator. By default, the freight operator is deemed to accept the assigned book shipment order unless the freight operator responds by rejecting the matching within a given time interval (e.g., 30 minutes). If the freight operator rejects the assignment, the matching engine 120 can rematch the booked shipment order with another available freight operator of the fleet.

FIG. 3E further illustrates an example assignment preview panel 350 in which the freight resources of a fleet are matched to a booked shipment order, with each freight resource (e.g., freight operator and/or freight vehicle) being associated with a feature that the fleet manager can select to effectuate the assignment displayed with the assignment preview panel 350.

In variations, the assignment preview panel 350 can allow for the fleet manager to alter the proposed matching. For example, the fleet manager can select a different freight operator of the fleet for a particular booked shipment order. In such an example, the fleet manager can select, for example, a freight operator from a candidate set of freight operators (e.g., those freight operators who are available and match to the booked shipment order).

FIG. 3F illustrates a booked shipment order and available freight operator matching panel for an example fleet management user-interface. The panel 360 can identify booked shipment orders as one of unassigned or assigned. A fleet manager can, for example, interact with selectable features of panel 360 to sort or filter a relational data structure (e.g., table 362) that references booked shipment orders of the fleet manager, based on a corresponding status parameter that identifies the respective booked shipment order as being assigned or unassigned. In one view, the booked shipment order panel 360 can list booked shipment orders which are unassigned, while in another view, the booked shipment order panel 360 can list booked shipment orders which are assigned. Each booked shipment order can be structured as an entry for the table 362, in association with parametric values that provide information about the shipment order (e.g., parametric values that reflect pickup/destination locations, timing parameters, and value for the respective shipment parameter).

In examples, the table 362 may further reference the booked shipment order with a parametric value representing the assigned freight operator. For booked shipment orders, the parameter for the assigned freight operator may identify a corresponding freight operator that has been assigned to the booked shipment order. For unassigned shipment orders, the assigned operator parameter may reflect the booked shipment order is unassigned. Additionally, each unassigned shipment order that is displayed with the table 362 may include an interactive feature 364 that is selectable to initiate an assignment matching process, as described with other examples. When an assignment matching process is initiated by input from the fleet manager, some examples provide for the matching process to determine matching criteria based at least in part on the corresponding shipment parameters. The matching criteria may be used to identify those freight operators who are associated with freight operator parameters 135 that satisfy the matching criteria. In examples, a matching process may be implemented to determine the set of matching freight operators, with the result representing the candidate set of freight operators for a booked and unassigned shipment order. From the candidate set, the fleet manager may, for example, select a freight operator for assignment to the unassigned and booked shipment order. Alternatively, the network computer system 100 may include logic to automatically select the freight operator for the booked and unassigned shipment order. As an addition or variation, the freight operator that is selected for a booked and unassigned shipment order may receive an invitation, to which the selected freight operator may respond before the assignment can take place. As another variation, the freight operator that is selected for a booked and unassigned shipment order may be assigned without input from that freight operator.

In examples, when the freight operator is assigned, the assignment component 124 may, for example, update a status state field of the corresponding freight operator record 134 to reflect the respective freight operator's new assignment. Likewise, in examples, the shipment record 114 for a booked and unassigned shipment order may also be updated in the shipment store 112, so as to reflect a corresponding status state change from booked/unassigned to assigned.

FIG. 3G illustrates a search panel for an example fleet management user-interface. In examples, the search panel 370 can include features to enable a fleet manager to perform a structured search, based on, for example, parametric values recorded with shipment orders (e.g., as provided with search parameters). Thus, for example, a fleet manager may utilize the search panel 370 to search for shipment orders, based on parametric values, the shipment parameters, a delivery radius, and a vehicle or trailer type. A result 372 may be rendered and provided to the fleet manager. In examples, the result 372 may be tabular, with each entry representing, for example, an open shipment order that matches the search parameters of the fleet manager. The fleet manager can select individual entries to view additional information about each open shipment order. As described with other examples, the fleet manager may also trigger the fleet management component 116 to perform actions on the open shipment orders, such as (i) an action to book an open shipment order without assigning or specifying a freight operator in advance, (ii) an action to implement a matching process where available freight operators that satisfy the matching criteria of the identified shipment order are listed for consideration and selection, and/or (iii) an action to assign the identified open shipment order to a selected freight operator.

FIG. 3H illustrates a historical shipment order panel for an example fleet management user-interface 300. In examples, the history panel 380 can list historical information about completed (or in-progress) shipping orders that are handled by a respective fleet manager. In examples, each shipping order can be associated with one or more parameters that reflect an administrative status of the completed order. In this way, the network computer system 100 can facilitate the fleet manager in managing freight operators and resources of the fleet.

FIG. 3I illustrates a fleet manager panel for facilitating a fleet manager in managing freight operators and resources of a fleet. The operator panel 390 may, for example, list freight operators in association with various types of profile information. The operator panel 390 can also include a feature to enable the fleet manager to add or subtract freight operators as a resource of the fleet. In this way, the fleet manager can add or subtract independent freight operators (e.g., operating self-owned freight vehicles) to their fleet as needed, from time-to-time.

Hardware Description

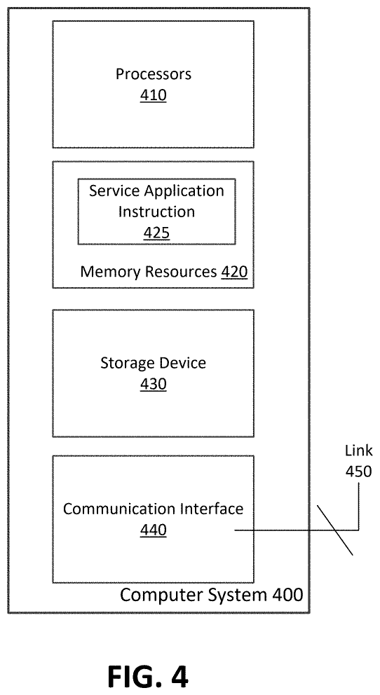

FIG. 4 illustrates a block diagram for a computer system on which examples described herein may be implemented. For example, in the context of FIG. 1, network computer system 100 may be implemented using a computer system or combination of computer systems such as described by FIG. 4.

In one implementation, the computer system 400 includes one or more processors 410, memory resources 420, and a communication interface 430. The computer system 400 includes at least one processor 410 for processing information. The memory resources 420 may include a random access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 425 for matching freight operators and shipment orders, as well as generating a fleet management user-interface while providing a fleet manager with a fleet management service. Additionally, the processor(s) 410 can execute the instructions 425 to implement example methods such as described with FIG. 2A and FIG. 2B.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive device data and/or service-specific information from devices, portals or other interfaces using a network link 450.

Examples described herein are related to the use of the computer system 400 for implementing the techniques described herein. According to one embodiment, those techniques are performed by the computer system 400 in response to the processor 410 executing one or more sequences of one or more instructions contained in the memory resource 420. Such instructions may be read into the memory resources 420 from another machine-readable medium, such as the storage device. Execution of the sequences of instructions contained in the memory resources 420 causes the processor 410 to perform operations and steps, as described herein. In alternative implementations, hard-wired circuitry may be used in place of or in combination with software instructions to implement examples described herein. Thus, the examples described are not limited to any specific combination of hardware circuitry and software.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A network computer system comprising:
one or more processors;
memory to store instructions;
wherein the one or more processors execute the instructions to:
provide an account interface to a fleet manager, the account interface being associated with an account of the fleet manager;
associate each freight operator of multiple freight operators with the account of the fleet manager;
implement a fleet booking process to book multiple shipment orders from one or more shipment sources;
obtain availability information for each freight operator of the multiple freight operators, the availability information including (i) an availability status of the freight operator during one or more future time intervals, and (ii) available location information of the freight operator during the one or more future time intervals;
match each of the multiple booked shipment orders with at least one of the freight operators of the multiple freight operators based on the availability information;
generate a preview assignment panel through the account interface of the fleet manager, the preview assignment panel identifying multiple matchings, wherein each matching identifies one of the multiple booked shipment orders and the freight operator that is matched to that booked shipment order, and wherein the preview assignment panel is interactive to enable the fleet manager to provide input to alter any of the multiple matchings; and
update the availability status of the freight operator of each matching.

2. The network computer system of claim 1, wherein the one or more processors communicate with a mobile computing device of each of the multiple freight operators to determine the availability information for each freight operator.

3. The network computer system of claim 1, wherein the one or more processors match each of the multiple booked shipment orders with at least one of the freight operators of the multiple freight operators by:
for each booked shipment order, determining a set of available freight operators of the multiple freight operators based at least in part on the availability status of the freight operator during a pickup window of the booked shipment order.

4. The network computer system of claim 3, wherein the one or more processors match each of the multiple booked shipment orders with at least one of the freight operators of the multiple freight operators by:
for each booked shipment order, selecting one of the available freight operators of the set to match with the booked shipment order based at least in part on the available location information.

5. The network computer system of claim 4, wherein for each available freight operator of the set, the available location information includes one or more of (i) an available location of the freight operator during the pickup window of the booked shipment order, (ii) a current location of the freight operator, (iii) an expected location of the freight operator, and/or (iv) a preference of the freight operator as to a route, pickup area, or delivery area.

6. The network computer system of claim 5, wherein for each booked shipment order, the one or more processors selects one of the available freight operators of the set by determining a distance or time of travel for the freight operator to a pickup location of the booked shipment order based on the available location information.

7. The network computer system of claim 1, wherein the preview assignment panel provides an input feature to enable the fleet manager to perform one or more of (i) confirm individual matchings of the multiple matchings, or (ii) change one or more of the matchings.

8. The network computer system of claim 1, wherein the one or more processors implement the fleet booking process by:
identifying fleet booking criteria for the account of the fleet manager;
accessing a listing of open shipment orders, each open shipment order of the listing being associated with a set of shipment parameters;
identifying a set of one or more open shipment orders of the listing which satisfy the fleet booking criteria; and
performing one or more booking operations to book multiple shipment orders of the set with the account of the fleet manager.

9. The network computer system of claim 8, wherein the fleet booking criteria is based at least in part on a set of fleet manager preferences.

10. The network computer system of claim 9, wherein the set of fleet manager preferences are based at least in part on a plurality of previously booked shipment orders.

11. The network computer system of claim 8, wherein the fleet booking criteria is based at least in part on a set of preferences of one or more of the multiple freight operators that are associated with the account of the fleet manager.

12. The network computer system of claim 11, wherein the fleet booking criteria is based at least in part on a route or lane previously driven by one or more of the multiple freight that are associated with the account of the fleet manager.

13. A network computer system comprising:
one or more processors;
memory to store instructions;
wherein the one or more processors execute the instructions to:
store a plurality of records, the plurality of records identifying a plurality of open shipment orders and a plurality of freight operators, wherein the record for each of the plurality of open shipment orders identifies a set of shipment parameters for that open shipment order, and wherein the record for each freight operator of the plurality of freight operators includes availability information that indicates an availability of the freight operator to pickup a shipment order in a particular region during an upcoming time interval;
perform one or more matching processes to match open shipment orders of the plurality of shipment orders and freight operators of the plurality freight operators, wherein the one or more processors perform the one or more matching processes using at least the set of shipment parameters identified by the record for each open shipment order of the plurality of open shipment orders and the availability information of each freight operator of the plurality of freight operators;
provide a user-interface for a fleet manager, the user-interface enabling the fleet manager to book an open shipment order that is identified by a result of the one or more matching processes;
record the booked shipment order as an unassigned shipment order for the fleet manager; and
enable the fleet manager to subsequently assign the booked and unassigned shipment order to one of the plurality of freight operators.

14. The network computer system of claim 13, wherein the one or more processors perform the one or more matching processes by determining, for each open shipment order of the plurality of open shipment orders, (i) a matching criteria that is based on a set of shipment parameters for that open shipment order, and (ii) one or more freight operators that are associated with freight activity information that satisfies the matching criteria for the open shipment order.

15. The network computer system of claim 14, wherein the one or more processors generate a fleet management user-interface for the fleet manager, the fleet management user-interface including a preview panel that includes a table to list each open shipment order in association with the one or more freight operators that satisfy the matching criteria for that open shipment order.

16. The network computer system of claim 15, wherein the one or more processors determine, from performing the one or more matching processes for each open shipment order, a quantitative marker that is indicative of a number of freight operators of the plurality of freight operators that satisfy the matching criteria for the open shipment order.

17. The network computer system of claim 13, wherein the one or more processors perform one or more matching processes by determining, for each freight operator of the plurality of freight operators, (i) a matching criteria that is based on freight activity data associated with that freight operator, and (ii) one or more open shipment orders that include shipment criteria which satisfies the matching criteria.

18. The network computer system of claim 17, wherein the one or more processors generate a fleet management user-interface for the fleet manager, the fleet management user-interface including a preview panel that includes a table to list each freight operator of the plurality of freight operators in association with one or more open shipment requests that satisfy the matching criteria for that freight operator.

19. The network computer system of claim 13, wherein the one or more processors execute the instructions to generate a fleet-manager user interface that includes:
a preview booking panel to provide, for each freight operator of the plurality of freight operators, an indicator of one or more open shipment requests that are matched to that freight operator; and
a booking feature to enable the fleet manager to provide input to book any one of the open shipment orders that are matched to the freight operator.

20. A non-transitory computer-readable medium that stores instructions, which when executed by one or more processors of a computer system, cause the computer system to perform operations that include:
storing a plurality of records, the plurality of records identifying a plurality of open shipment orders and a plurality of freight operators, wherein the record for each of the plurality of open shipment orders identifies a set of shipment parameters for that open shipment order, and wherein the record for each freight operator of the plurality of freight operators identifies availability information that indicates an availability of the freight operator to pickup a shipment order in a particular region during an upcoming time interval;
performing one or more matching processes to match open shipment orders of the plurality of shipment orders and freight operators of the plurality freight operators, wherein the one or more processors perform the one or more matching processes using at least the set of shipment parameters identified by the record for each open shipment order of the plurality of open shipment orders and the availability information of each freight operator of the plurality of freight operators;
providing a user-interface for a fleet manager, the user-interface enabling the fleet manager to book an open shipment order that is identified by a result of the one or more matching processes;
recording the booked shipment order as an unassigned shipment order for the fleet manager; and
enabling the fleet manager to subsequently assign the booked and unassigned shipment order to one of the plurality of freight operators.
